(19) United States
(12) Patent Application Publication
(10) Pub. No.: US 2007/0068734 A1
(43) Pub. Date: Mar. 29, 2007

(54) Williams Link, II, a system, method and apparatus for pollution-free removal of fluids from mechanical reservoirs

(76) Inventors: Judy E. Williams, Churchville, VA (US); James C. Williams JR., Churchville, VA (US)

Correspondence Address: JUDY E. WILLIAMS, P.O. BOX 36, CHURCHVILLE, VA, 24421, US

(21) Appl. No.: 11/208,938

(22) Filed: Aug. 23, 2005

(51) Int. Cl. F16N 33/00

(52) U.S. Cl. 184/1.5

(57) ABSTRACT

The present invention is a system, method, and apparatus that will prevent the environmental hazards and pollution that occur from spillage when oil and other contaminating liquids are removed from mechanical devices, such as an engine, transmission, gear box, differential, or any other oil pan/reservoir found in, but not limited to, automotive, excavating, industrial, and farming equipment and machines. The system and method described requires a banjo bolt—with a check valve manufactured internally, along with a banjo bolt fitting—installed in the bottom of the engine, transmission, gear box, differential, or any other oil pan/reservoir, working in conjunction with a connector hose, a universal quick coupling device and a fluid extraction apparatus, allowing for the spill-proof extraction of the lubricant held in the engine, transmission, gear box, differential, or any other oil pan/reservoir.

### CROSS REFERENCES

U.S. Pat. No. 1,886,098 November, 1932 Hedglon. 184/1.5
U.S. Pat. No. 2,158,914 May, 1939 Rinehart 184/1.5
U.S. Pat. No. 2,249,303 July, 1941 Smith 184/1.5
U.S. Pat. No. 2,320,048 May, 1943 Parson 184/1.5
U.S. Pat. No. 2,366,073 December, 1944 Vallerie 184/1.5
U.S. Pat. No. 2,425,848 August, 1947 Vawter 184/1.5
U.S. Pat. No. 2,454,585 November, 1948 Alderman 184/1.5
U.S. Pat. No. 2,554,389 May, 1951 Stevens 184/1.5
U.S. Pat. No. 2,594,779 April, 1952 Huffman 184/1.5
U.S. Pat. No. 3,810,487 May, 1974 Cable, et. al 137/351.
U.S. Pat. No. 4,776,431 October, 1988 Poling 184/1.5
U.S. Pat. No. 4,807,674 February, 1989 Sweet 184/1.5
U.S. Pat. No. 4,854,277 August, 1989 Kenney 184/1.5
U.S. Pat. No. 4,884,660 December, 1989 Bedi 184/1.5
U.S. Pat. No. 5,208,198 May, 1993 Bedi 184/1.5
U.S. Pat. No. 5,372,219 December, 1994 Peralta 123/196.
U.S. Pat. No. 6,123,174 September 2000 Elkin, et. al 184/1.5

### BACKGROUND OF INVENTION

The present invention relates generally to the field of transportation vehicles and machinery and specifically to the leak-proof removal of fluids from the various reservoirs found within the vehicles and machinery, via the Williams Link II, a system, method, and apparatus designed to extract the fluids without polluting spillages, which are a common-place occurrence, both in the private and industrial sectors.

There is currently not a universally used method of extracting these fluids without allowing at least some of the liquid to spill onto the ground or run into and over other parts of the equipment to later drip onto the ground and pollute. The industry's most common method for draining fuels, oils, and other lubricants and coolants from oil pans and other reservoirs relies on gravity as the force behind the evacuation process. Some technicians use a vacuum or a suction pumping device. Current fluid evacuation procedures require that the mechanic or other technician access the plug as best they can, place a receptacle in at least close proximity to where the fluid will drain out and into the receptacle, remove the plug, push a button, twist a bolt, or turn a lever or plug in a hose to activate the spring-loaded plunger inside to begin the fluid flow. Despite best efforts to keep the fluids from spilling onto the ground, that is invariably the outcome, because when the gravitational flow begins, it is difficult to control the flow of fluids from the reservoir/pan to a waste receptacle. Compounding the problem is the polluting that occurs when changing oils and fluids in the work field, where the wind often blows the fluids being drained all over the ground.

Years of experience and observation in the vehicle and industrial equipment service industry have allowed one of the present invention's inventors first-hand observations of fluids being removed from the current-day systems and spilling to the ground, and polluting the soil and waterways. Because of the current method used by those skilled in the art of removing these petroleum or synthetic-based fluids and lubricants, spills result and present an environmental problem that impacts the ecological system. In addition, human contact with these fluids pose possible health related problems for the mechanics and other technicians who are responsible for removing and replacing these fluids.

### BRIEF SUMMARY OF THE INVENTION

The present invention is a system, method and apparatus to be used in place of a standard oil plug during the removal of lubricants, fuels, or other fluids from an engine, transmission, gear box, differential, fuel reservoirs found in automobiles, industrial equipment or machines, heavy earth moving equipment, agricultural farming equipment, or any machines operated by internal combustion engines, or any machines using lubricants, fuels or coolants, in order to eliminate polluting spillages during the removal process.

The use of a check valve built into the banjo bolt at the time of manufacturing will hold the fluid in the reservoir until the check valve is activated by a vacuum or pumping fluid extraction machine to start the evacuation process. The present invention is also designed with a break-away groove at the edge of the thread at the sealing area of the reservoir or pan. This safety element ensures there will be no spillage, should the drain plug be broken or severed from the engine, transmission, differential, gearbox, tank, or reservoir. An interior system stays in place with the valve, spring, and seat assembly, holding the valve closed and keeping the reservoir fluid in place, preventing polluting spillages.

### BRIEF DESCRIPTION OF THE DRAWING

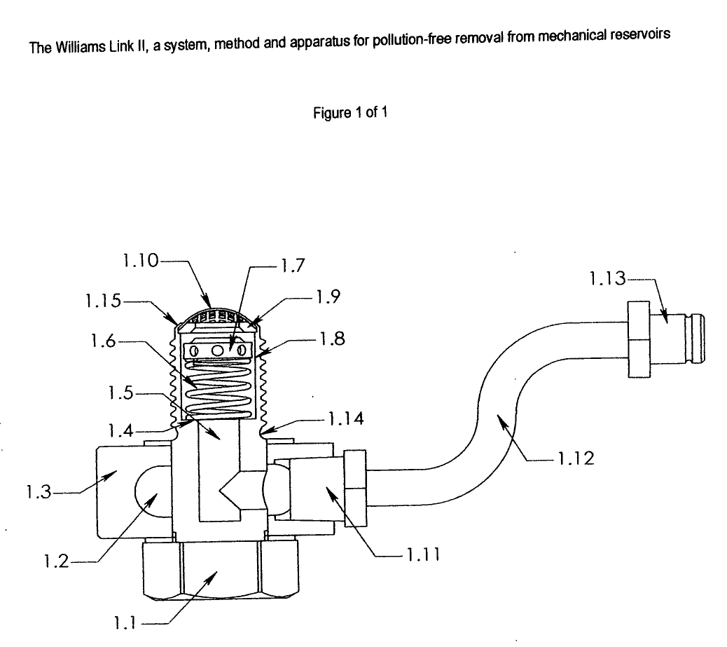

The drawing (FIG. 1) included in this application represents the invention's banjo bolt apparatus and its various internal and external components. The elements represented in this drawing are as follows:

1.1 A banjo bolt

1.2 A banjo bolt fitting galley

1.3 A banjo bolt fitting

1.4 A banjo bolt spring seat

1.5 A banjo bolt port

1.6 A banjo bolt spring

1.7 A banjo bolt plunger

1.8 The banjo bolt housing, which is the bore of the bolt

1.9 A banjo bolt plunger seat

1.10 A built-in screen to catch debris

1.11 A banjo port for hose connection

1.12 A drain hose

1.13 A universal quick coupler

1.14 A break-away groove to prevent spillage

1.15 A bendable edge to hold screen, seat, and plunger in place

### DETAILED DESCRIPTION Y OF INVENTION

The present invention provides a system, method, and apparatus for removing oil from the reservoirs found in automobiles, industrial and agricultural equipment and machines, boats, ships, airplanes, and the like. The features and advantages of the present invention will become more apparent from the detailed description set forth below when taken in conjunction with the drawings.

It is possible for oils and other lubricants, as well as other liquids, to be removed from holding containers—such as reservoirs, oil pans, and the like—without polluting and otherwise contaminating spillage occurring at the various stages of the process.

Removing old lubricants and other fluids, such as hydraulic, engine, and gear oils, fuels, and antifreeze, from reservoirs, filters, and other components in mobile and stationery equipment, pose a threat to the environment in two specific ways. First, these fluids are hazardous materials that pollute the environment when allowed to spill onto the ground and into gutters, and work their way into the water tables during the process of exchanging them. Second, because of the current method used by most of those skilled in the art of removing these petroleum or synthetic-based fluids and lubricants—namely through a drain plug that depends on gravity to drain the fluids—spillage is a common-place occurrence in the private, industrial, and agricultural sectors. That is, when a person drains an oil pan/reservoir, removes an oil filter, oil pan, line, or hose containing these fluids and lubricants, there is not a good way for even certified-mechanics to do so without allowing at least some of the liquid to spill onto the ground, or onto the undercarriages of the vehicles, machines, or equipment where it will later drip onto the ground and pollute.

The current-day drain plug is typically placed underneath or on the side of the engine, differential, transmission, gear boxes, hydraulic cylinders, and other reservoirs. Once the technician locates and opens the drain plug, the gravitational pull begins emptying the fluids into a receiving receptacle placed, ideally, under the machine part to catch the fluid, such as a pan or a jug. Despite best efforts to keep the fluids from spilling onto the ground, that is invariably the outcome, because of a receptacle that is often too small to hold all of the draining fluids, the wind blowing the fluid away from the receptacle, or one that is improperly placed, missing the drain plug flow entirely. Both situations lead to overflow and spillage of the contaminants.

In-depth research of the referenced patents demonstrates that methods exist that help minimize the drawbacks of changing these fluids; however, to date, most have proven totally ineffective, because of inherent limitations.

The present invention eliminates the deficiencies of these predecessors by building a check valve into a banjo bolt at the time the banjo is manufactured.

The present invention is now described in more detail herein in terms of the above details. This is for convenience only and is not intended to limit the application of the present invention. In fact, after reading the following description, it will be apparent to one skilled in the art of how to implement the following invention in alternative embodiments (e.g., other types drain plugs). The terms “oil,” “lubricants,” “fluids,” and “liquids,” and the plural form of these terms may be used interchangeably throughout herein to refer to those who would access, use, and/or benefit from the elements that the present invention provides for changing oil, fuels, or any other fluids.

In an embodiment, the present invention makes it possible for oils, fuels, and other lubricants (such as synthetic oils) to be removed from an engine, transmission, gear box, differential, fuel reservoir, or any other reservoir used in automobiles, industrial and agricultural equipment and machines, without polluting spillages occurring. The present invention's apparatus accomplishes this by replacing the current oil plug with a banjo bolt (1.1) that contains a check valve, which is manufactured into the banjo bolt and is comprised of a spring (1.6), a plunger seat (1.9), a plunger (1.7), and a spring seat (1.4) in the housing, which is the bore of the bolt (1.8). To accomplish a spill-proof extraction of fluids, the banjo bolt and its internal check valve do not depend on gravity to start the flow from the reservoir. Rather, they work in conjunction with an existing suction device designed to pull the fluid out of the reservoir through the banjo bolt check valve and port (1.5), which flows into the banjo fitting galley (1.2), out of the banjo fitting (1.3), through the banjo port for hose connection (1.11). The fluid then flows out of a hose (1.12) that is conveniently placed for the technician's easy retrieval, and through the universal quick coupler (1.13) and into a fluid extraction machine. Most such fluid extraction devices contain an environmentally sound waste receptacle. To further protect the environment by protecting it from spillage of contaminating fluids, the apparatus also has a break-away groove (1.14) at the edge of the thread at the sealing area of the reservoir or pan. Should the bolt be severed or damaged, the break-away groove prevents spillage and leakage, because it is placed below the check-valve, which holds the fluid in the reservoir.

The banjo bolt also has a built—in screen (1.10) to protect the check valve from solid particles, such as dirt or other debris. A bendable edge (1.15) holds the screen, seat, and plunger in place.

From the banjo bolt to the fluid extraction device, the entire fluid removal process of the present invention is efficient and spill-proof, making the invention an environmental advantage over present systems available.

What we claim as our invention is:

1. A spill-proof, environmentally sound system, method, and apparatus for safely removing lubricants and other fluids from automotive, industrial, and agricultural engines, transmissions, gear boxes, differentials, hydraulic tanks, fuel tanks, filters, and any other reservoir that contains fuels, and/or lubricants, through the use of a banjo bolt with a check valve that is manufactured internally and is vacuum-engaged, and screen-topped and has a break-away groove, and working in conjunction with an existing suction device for fluid removal, via a hose that is routed from the banjo bolt fitting to a quick connect coupling device that is attached to the opposite end of the hose, and located in an easily accessible area for the technician to access and connect to the oil change system.

2. A check valved banjo bolt, designed to facilitate the flow of fluids from reservoirs referenced in claim 1 and to stop the flow of fluids from such reservoirs by means of a break-away groove machined into the banjo bolt at the point of connection to an oil pan/reservoir's outside surface, allowing the check valve end of the banjo bolt to remain in the oil pan/reservoir to prevent spills to the soils and waterways, should the banjo bolt fitting be struck or broken off by rocks or other debris.

3. A spill-proof, environmentally safe system, method, and apparatus for removing automotive, industrial and agricultural mechanical fluids from reservoirs referenced in claim 1, via the use of a vacuum-engaged, check-valved banjo bolt and banjo bolt fitting.
